(19) United States
(12) Patent Application Publication
(10) Pub. No.: US 2004/0023192 A1
(43) Pub. Date: Feb. 5, 2004

(54) Book having sound generator built therein

(75) Inventor: Jae-Hwan Lee, Kyunggi-do (KR)

Correspondence Address: GREENBLUM & BERNSTEIN, P.L.C., 1950 ROLAND CLARKE PLACE, RESTON, VA, 20191, US

(73) Assignee: S.W Reading Co., Ltd., Kyunggi-do (KR)

(21) Appl. No.: 10/628,255

(22) Filed: Jul. 29, 2003

(30) Foreign Application Priority Data
Jul. 29, 2002 (KR) 20-2002-22595

(51) Int. Cl. G09B 5/00

(52) U.S. Cl. 434/156; 434/317; 434/307 R; 434/169

(57) ABSTRACT

Disclosed herein is a book having a sound generator built in that can be implemented at a low price and can be separated from the book. The book includes a book body, and a sound generator that can be separated from the book body, wherein the book body includes a front cover, a rear cover, and a plurality of inner leaves located between the front cover and the rear cover, on which contents to be delivered to a reader are represented in letters, symbols and/or illustrations, wherein the front cover or the rear cover includes a marginal space element at which the sound generator is seated, and an attachment/detachment means installed at the marginal space element, for separately supporting the sound generator, and wherein the sound generator includes a page setting means, a page display means for visually displaying a page set in the page setting means, a sound storage means for storing sound data corresponding to the contents of each of the inner leaves, a sound output means for outputting the sound data with a sound, and a control means for controlling the output of the sound data corresponding to the page set in the page setting means to the sound output means.

### BACKGROUND OF THE INVENTION

1. Field of the Invention

The present invention relates to a book having a sound generator built therein, and more particularly, to a book having a sound generator built therein, which can be implemented at a low price and used with it separated from the book.

2. Background of the Related Art

Generally, in most books for an infant, illustrations and compositions are shown on each page of the book. At this time, the infant learns the language and letters by associating the composition corresponding to the illustration and hearing the reading of the book by the parents. In order to meet this aspect of the learning in the infant, there was proposed Korean Utility Model Publication No. 22375 entitled “book having sound generator built therein” in 1999 for outputting a content corresponding to a given page with a sound.

FIG. 1 is a perspective view illustrating the construction of a conventional book having a sound generator built in and FIG. 2 is a cross-sectional view illustrating the construction of the conventional book having the sound generator built in.

As shown in FIG. 1 and FIG. 2, the conventional book having the sound generator built in includes a plurality of the pages 20; 22, 24, 26 and 28 located inside a cover 10 of the book. The cover 10 consists of a thick front base 12, a rear base 14, a center base 16 located between the front and read bases 12 and 14, and a thin hinge element 18 for connecting the center base 16 to the front base 12 and the rear base 14 at the right and left of the center base 16.

A plurality of through-holes 20a, 20b, 20c, 20d and 20e that are installed at the inner bottom of the book, which exposes photoelectric conversion elements Q1-Q5, respectively, such as a photo transistor, are formed on the inner side around the hinge element 18 of the read base 14. Thus, light reaches the photoelectric conversion elements Q1-Q5 through the through-holes 20a, 20b, 20c, 20d and 20e that are cooperatively operated with the operation of turning over the leaves 20; 22, 24, 26 and 28 of the book. Thereafter, the photoelectric conversion elements Q1-Q5 output a page turning-over signal to a controller (not shown). The controller then outputs corresponding sound data via the speaker, so that a sound related to a corresponding page is automatically outputted. In the drawings, unexplained reference numerals 14a indicates a speaker hall, SW1-SW3 indicate mode select switches, SW4 indicates a power switch and LED indicates an operating display device.

However, the conventional book having the sound generator built in has a shortcoming that its operation itself is not performed when the through-holes are clogged due to variance of the leaves or intervention of an alien substance, etc. even with a high manufacturing cost. In particular, the conventional book having the sound generator built in has a problem that it has a limited use since electrical and mechanical structures related to page turning-over sensing and sound generation cannot be separated from the book.

### SUMMARY OF THE INVENTION

Accordingly, the present invention is contrived to solve the above mentioned problems and an object of the present invention is to provide a book having a sound generator built therein, that can be implemented at a low price and can be used with it easily separated.

To achieve these objects, according to the present invention, there is provided a book having a sound generator built therein, including a book body, and a sound generator that can be separated from the book body, wherein the book body includes a front cover, a rear cover, and a plurality of inner leaves located between the front cover and the rear cover, on which contents to be delivered to a reader are represented in letters, symbols and/or illustrations, wherein the front cover or the rear cover includes a marginal space element at which the sound generator is seated, and an attachment/detachment means installed at the marginal space element, for separately supporting the sound generator, and wherein the sound generator includes a page setting means, a page display means for visually displaying a page set in the page setting means, a sound storage means for storing sound data corresponding to the contents of each of the inner leaves, a sound output means for outputting the sound data with a sound, and a control means for controlling the output of the sound data corresponding to the page set in the page setting means to the sound output means.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view illustrating the construction of a conventional book having a sound generator built therein;

FIG. 2 is a cross-sectional view illustrating the construction of the conventional book having the sound generator built therein;

FIG. 3 is an explored perspective view illustrating the construction of a book having a sound generator built therein according to an embodiment of the present invention;

FIG. 4 is a front view of the sound generator provided in the book having the sound generator built therein according to the present invention;

FIG. 5 is a rear view of the sound generator provided in the book having the sound generator built therein according to the present invention; and

FIG. 6 is an electrical block diagram illustrating the sound generator provided in the book having the sound generator built therein according to the present invention.

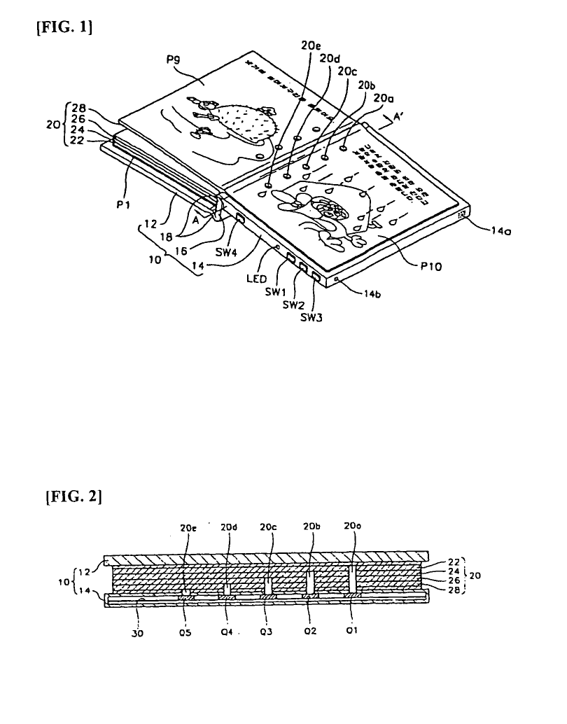

### DETAILED DESCRIPTION OF THE PREFERRED EMBODIMENT

A book having a sound generator built therein according to a preferred embodiment of the present invention will now be described in detail with reference to the accompanying drawings.

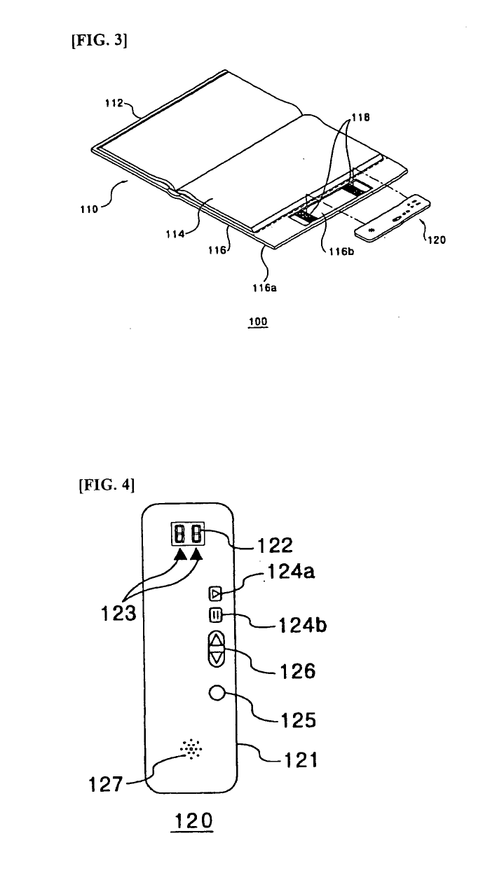

FIG. 3 is an explored perspective view illustrating the construction of the book having the sound generator built therein according to the present invention.

As shown in FIG. 3, the book having the sound generator built therein 100 largely includes a book body 110, and a sound generator 120 that is attachable to and detachable from the book body 110.

The book body 110 includes a front cover 112, a rear cover 116, and a plurality of inner leaves 114 located between the front cover 112 and the rear cover 116, on which contents to be delivered to a reader are illustrated in letters, symbols, illustrations, etc. In the above, the front cover 112 may be formed using the same material as the inner leaves 114 but preferably formed using a material thicker than the inner leaves 114. It is required that the horizontal length of the rear cover 116 is made larger than the inner leaves 114 so that a space 116a (hereinafter referred to as ‘marginal space element’) to which the sound generator 120 is attached can be provided. Further, it is required that the rear cover 116 is made using a material and thickness having a sufficient strength so that it is not torn even in various use environments under a condition that the sound generator 120 is attached to it. Furthermore, it is preferred that a keeping groove 116b having the same size as the sound generator 120 is formed at the right place of the marginal space element 116a so that the sound generator 120 can be firmly supported. An unexplained reference numeral 118 indicates a male Velcro tape for fixing the sound generator 120. The number of the male Velcro tapes 118 may be varied if necessary.

FIG. 4 is a front view of the sound generator provided in the book having the sound generator built therein and FIG. 5 is a rear view of the sound generator provided in the book having the sound generator built therein according to the present invention.

As shown in FIG. 4 and FIG. 5, various electrical and mechanical components related to the operation of the sound generator 120 are positioned at the front of a housing 121 in which various components of the sound generator 120 are built. For example, a page display 122 for displaying a page of the inner leaves 114 in the book body 110 containing the sound that is being currently generated, may be located at the top of the housing 121. Further, a page setting button 123 may be located below the page display 122. A reproducing button 124a for generating a command to reproduce the sound and a stop button 124b for generating a command to stop the sound, are located at the right place of the front of the housing 121. A volume increase/decrease button 126 for increasing/decreasing the volume of the sound may be further provided.

In the above construction, the page display 122 may be implemented using, for example, a 7's segment numerical display wherein each segment is formed using a LED. In the case where a total number of the inner leaves 124 is two digits, two numerical displays are required on the page display 122. In the case where a total number of the inner leaves 124 is three digits, three numerical displays are necessary on the page display 122. The page setting button 123 may be implemented using an up-count button wherein the number is increased by one pressing manipulation. In the present embodiment, the up-count button may be provided every figure. Of course, the page setting button 123 may be implemented using an up/down-count button for convenience' sake. In the drawings, unexplained reference numerals 125 indicates a power switch for turning on or off the power and 127 indicates a speaker hall through which the output sound of the speaker flows out of the housing 121.

Meanwhile, female Velcro tapes 128 at a location corresponding to the male Velcro tapes 118 provided in the book body 110 are attached to the rear of the housing 121. The male Velcro tapes may be attached to the rear of the sound generator 120 and the female Velcro tapes may be attached to the keeping groove 116b of the book body 110. An unexplained reference numeral 129 indicates a battery replacement cover (not shown) that is used to replace the battery.

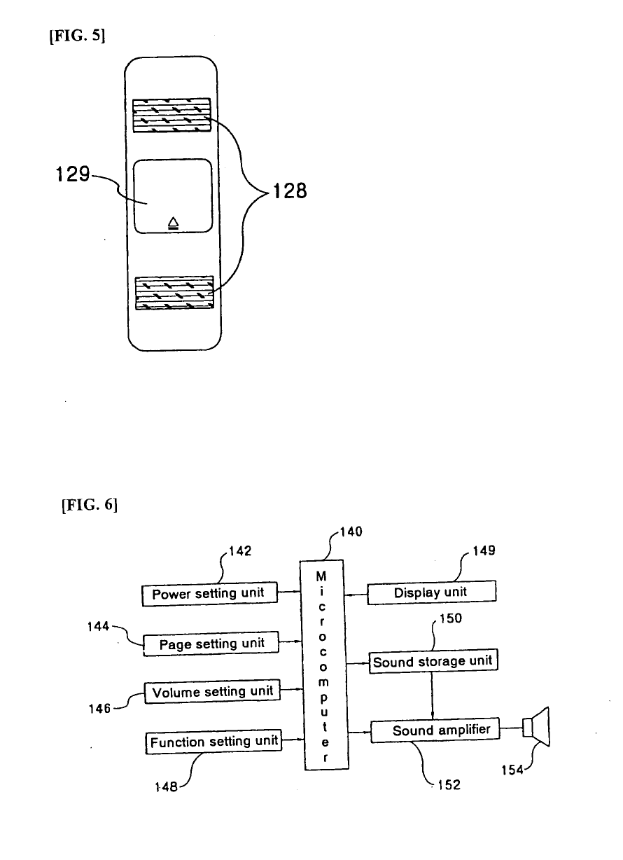

FIG. 6 is an electrical block diagram illustrating the sound generator provided in the book having the sound generator built therein according to the present invention.

As shown in FIG. 6, the electrical construction of the sound generator 120 provided in the book having the sound generator built therein 100 of the present invention includes a power supply unit 142 for supplying the power to respective components, a page setting unit 144 for setting a desired page from which the sound is to be outputted, a volume setting unit 146 for setting a desired volume, a function setting unit 148 for selecting various functions including a reproduction function and a stop function, a display unit 149 for displaying a desired page from which the sound is to be outputted, a sound storage unit 150 for storing various sound information corresponding to the contents of the inner leaves 114 of the book body 110 in a digital data, a sound amplifier 152 for converting the digital sound data stored at the sound storage unit 150 into an analog signal and then amplifying the signal, a speaker 154 for outputting the electrical signal amplified via the sound amplifier 152 with a sound, and a microcomputer 140 for controlling the entire operation of the components.

In the above construction, the power supply unit 142 may be implemented using an independent power such as a battery. In addition to it, the power supply unit 142 may be implemented using a dependent power that is obtained by reducing, rectifying and smoothing the common AC power using an adaptor. In this case, it is required that a power jag into which the power plug of the adaptor is inserted be provided in the housing 121. The page setting unit 144 may consist of the page setting button 123 and its surrounding circuit elements. The volume setting unit 146 may consist of the volume setting button 126 and its surrounding circuit elements. The display 149 may consist of the page display 122 and its surrounding circuit elements. The function setting unit 148 may consists of the reproducing button 124a, the stop button 124b and its surrounding circuit elements. Further, the sound storage unit 150 may consist of an integrated circuit for a sound memory.

In the book having the sound generator built therein 100 constructed above, a user manipulates the page setting button 123 of the sound generator 120 in a state where a desired page is opened in the book body 110, thus matching the number of the page display 122 to the opened page of the book body 110. In this state, if the user presses the reproducing button 124a, the microcomputer 140 confirms it and then controls the sound storage unit 150 to output the digital sound data corresponding to the page. Next, the sound amplifier 152 converts the digital sound data into the analog signal and then amplifies the signal. The speaker 154 then outputs the amplified signal with a sound, so that the sound flows out of the speaker hall 127.

In this state, if the user presses the volume setting button 126 in order to adjust the volume, the microcomputer 140 applies an amplification control signal to the sound amplifier 150. As the degree of amplification of the sound amplifier 150 is adjusted accordingly, the output sound volume of the speaker 154 is adjusted.

Meanwhile, the sound generator of the present invention can be used by referring or not referring to the contents of the inner leaves 114 of the book, in a state where the sound generator is separated from the book body 110. Further, if any manipulation of the button is not performed for a predetermined time period with the power on in order to prevent power consumption, the sound generator may be constructed so that it is automatically switched into a sleep mode. In this case, not only the sound is not outputted via the speaker 154 but also the page display 122 is not driven. It is thus possible to prevent power consumption. Further, if there is any manipulation of the button under the sleep mode, the sleep mode is automatically released.

The book having the sound generator built therein according to the present invention is not limited to the above embodiments but various modifications can be made within the scope of the present invention. For example, in the above embodiments, although the attachment/detachment means to and from the book body of the sound generator is implemented using the Velcro tape, the present invention is not limited thereto. Instead, a magnet or other attachment/detachment means having a resilient support force may be used. Further, a repetition reproducing button, etc. may be additionally provided in the function setting unit. Also, the marginal space element to which the sound generator is attached may be formed at the top or bottom of the rear cover, or at the front cover.

As described above, according to the book having the sound generator built therein, the present invention has new effects that it can be implemented at a low price and used with it easily separated from the book to increase a user's convenience.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A book having a sound generator built therein, comprising:
a book body, and
a sound generator that can be separated from the book body,
wherein the book body includes a front cover, a rear cover, and a plurality of inner leaves located between the front cover and the rear cover, on which contents to be delivered to a reader are represented in letters, symbols and/or illustrations,
wherein the front cover or the rear cover includes a marginal space element at which the sound generator is seated, and an attachment/detachment means installed at the marginal space element, for separately supporting the sound generator, and
wherein the sound generator includes a page setting means, a page display means for visually displaying a page set in the page setting means, a sound storage means for storing sound data corresponding to the contents of each of the inner leaves, a sound output means for outputting the sound data with a sound, and a control means for controlling the output of the sound data corresponding to the page set in the page setting means to the sound output means.

2. The book claimed as claim 1, wherein the attachment/detachment means consists of Velcro tapes that are formed in the marginal space element and the sound generator, respectively.

3. The book claimed as claim 2, wherein the marginal space element has a keeping groove at which the sound generator is seated, and the Velcro tapes are attached to the keeping groove.

4. The book claimed as any one of claims 1 to 3, wherein the marginal space element has a portion larger than the horizontal length of the inner leaves in the rear cover.
